(19) United States
(12) Patent Application Publication
(10) Pub. No.: US 2001/0030779 A1
(43) Pub. Date: Oct. 18, 2001

(54) Projection device with a cross dichroic mirror set

(76) Inventor: Leit Ho, Taipei City (TW)

Correspondence Address: WINSTON HSU, 5 F, N0. 389, Fu-Ho Road, Yung-Ho City, Taipei Hsien, 234, TW

(21) Appl. No.: 09/779,506

(22) Filed: Feb. 9, 2001

(30) Foreign Application Priority Data
Apr. 14, 2000 (TW) 89206067

(51) Int. Cl. G03B 21/00; G02B 5/32

(52) U.S. Cl. 359/20; 353/31

(57) ABSTRACT

A projection device has a light source, a polarization converter, a cross dichroic mirror set that has two dichroic mirrors, a modulation device and a projection lens. The light source provides white unpolarized light. The polarization converter converts the white unpolarized light into white polarized light. The two dichroic mirrors have a cross-like arrangement and are used to separate the white polarized light into three monochromatic polarized beams. The modulation device is positioned adjacent to the cross dichroic mirror set. The modulation device modulates the three monochromatic polarized beams to form three monochromatic polarized modulated beams, and reflects the three monochromatic polarized modulated beams to the two dichroic mirrors. The two dichroic mirrors recombine the three monochromatic polarized modulated beams to form a white polarized modulated beam. Finally, the projection lens projects the white polarized modulated beam to form an image.

### BACKGROUND OF THE INVENTION

1. Field of the Invention

The present invention relates to a projection device. More specifically, a projection device with a cross dichroic mirror set is disclosed.

2. Description of the Prior Art

Please refer to FIG. 1. FIG. 1 is a ray diagram for a prior art projection device 10. The projection device 10 comprises a light source 12, a UV/IR (ultraviolet/infrared) cut filter 13, three dichroic mirrors 14, 16 and 18, two reflectors 20 and 22, three polarization converters 24, 25 and 26, three polarizing beam splitters 27, 28 and 29, three retarders 30, 31 and 32, three reflective liquid crystal display panels 33, 34 and 35, a color cube 38 and a projection lens 40. The light source 12 provides white unpolarized light L*. The UV/IR cut filter 13 is used to filter out ultraviolet and infrared light from the white unpolarized light L*. The three dichroic mirrors 14, 16 and 18 separate the white unpolarized light L* into three monochromatic unpolarized beams R*, G* and B*. The two reflectors 20 and 22 are used to reflect the three monochromatic unpolarized beams R*, G* and B*. The three polarization converters 24, 25 and 26 polarize the three monochromatic unpolarized beams R*, G* and B* into three monochromatic polarized beams R, G and B. The three reflective liquid crystal display panels 33, 34 and 35 modulate the three monochromatic polarized beams R, G and B to form three monochromatic polarized modulated beams R′, G′ and B′. The color cube 38 combines the three monochromatic polarized modulated beams R′, G′ and B′ to form a white polarized modulated beam L′. The projection lens 40 projects the white polarized modulated beam L′ to form an image on a screen 44.

As shown in FIG. 1, the ultraviolet and infrared light of the white unpolarized light L* provided by the light source 12 is filtered out by the UV/IR cut filter 13, and then the white unpolarized light L* is separated into the three monochromatic unpolarized beams R*, G* and B* by the three dichroic mirrors 14, 16 and 18. The three monochromatic unpolarized beams R*, G* and B* are polarized into three monochromatic polarized beams R, G and B by the three polarization converters 24, 25 and 26, respectively. The three monochromatic polarized beams R, G and B are passed to the three reflective liquid crystal display panels 33, 34 and 35 by the three polarizing beam splitters 27, 28 and 29, and the three retarders 30, 31 and 32. The three reflective liquid crystal display panels 33, 34 and 35 modulate the three monochromatic polarized beams R, G and B to form three monochromatic polarized modulated beams R′, G′ and B′, and then the three reflective liquid crystal display panels 33, 34 and 35 reflect the three monochromatic polarized modulated beams R′, G′ and B′ to the color cube 38. The color cube 38 combines the three monochromatic polarized modulated beams R′, G′ and B′ to form the white polarized modulated beam L′, and reflects the white polarized modulated beam L′ to the projection lens 40 to form an image on the screen 44.

To present an image on the screen 44, the white unpolarized light L* provided by the light source 12 undergoes the following processes: separation, polarization, modulation, combination and projection. However, because different components are used for each of the process steps in the projection device 10, the number of components in the projection device 10 cannot be decreased. Thus, the projection device 10 suffers from problems, such as: the light has a long traveling distance, the projection device 10 has a large size, the projection device 10 is heavy and expensive, and so on. If one component of a projection device could be used to handle more than one of the processes described above, the number of components in the projection device would be decreased.

### SUMMARY OF THE INVENTION

It is therefore a primary objective of this invention to provide a projection device with a cross dichroic mirror set. The number of components in the present invention projection device is therefore less than the number of components in the prior art projection device.

The present invention projection device comprises a light source, a polarization converter, a cross dichroic mirror set that has two dichroic mirrors, a modulation device and a projection lens. The light source provides white unpolarized light. The white unpolarized light is converted into white polarized light by the polarization converter. The two dichroic mirrors, having a cross-like arrangement, and are used to separate the white polarized light into three monochromatic polarized beams. The modulation device comprises three modulation units. The three modulation units are positioned adjacent to the cross dichroic mirror set, and are used to modulate the three monochromatic polarized beams to form three monochromatic polarized modulated beams and to reflect the three monochromatic polarized modulated beams to the two dichroic mirrors. The two dichroic mirrors recombine the three monochromatic polarized modulated beams to form a white polarized modulated beam. Finally, the white polarized modulated beam is projected to form an image by the projection lens.

Because the cross dichroic mirror set is used to separate the white polarized light into the three monochromatic polarized beams, and is used to recombine the three monochromatic polarized modulated beams to form a white polarized modulated beam, the number of components in the present invention projection device is less than the number of components in the prior art projection device, this makes the projection device ultra-compact.

### BRIEF DESCRIPTION OF THE DRAWINGS

FIG. 1 is a ray diagram of a prior art projection device.

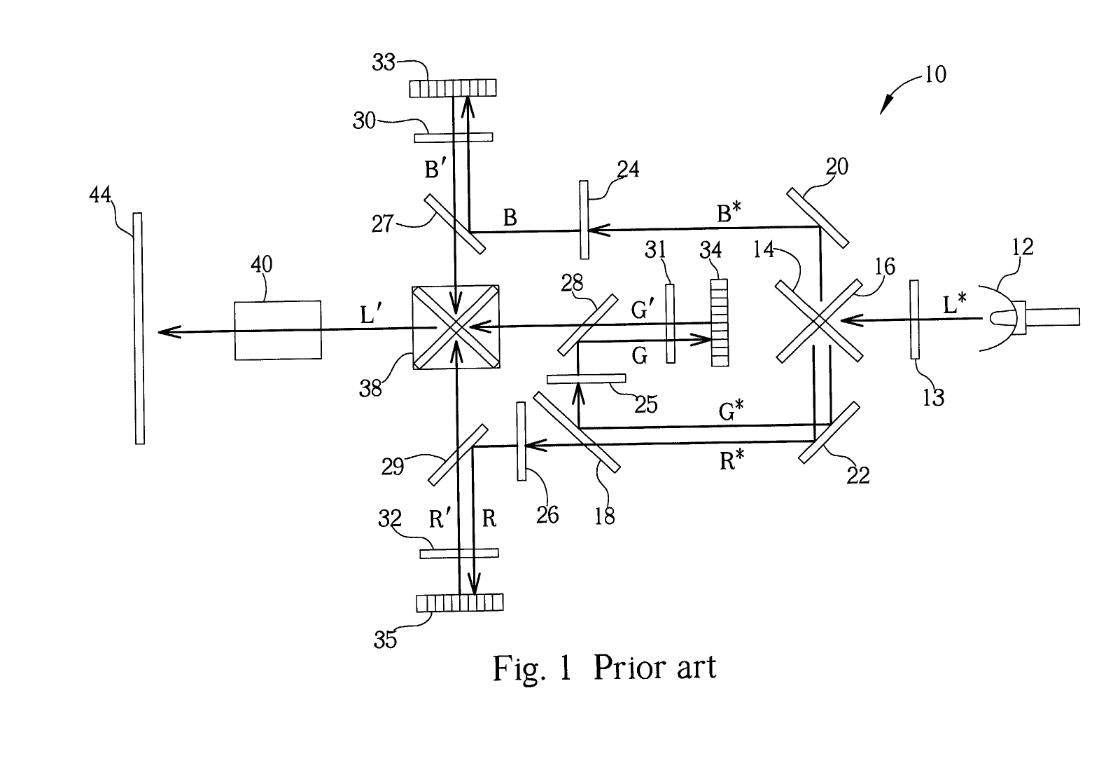

FIG. 2 is a schematic view of a present invention first embodiment projection device.

FIG. 3 is a ray diagram of the projection device in FIG. 2.

FIG. 4 is a ray diagram of a present invention second embodiment projection device.

FIG. 5 is a ray diagram of a present invention third embodiment projection device.

### DETAILED DESCRIPTION OF THE PREFERRED EMBODIMENT

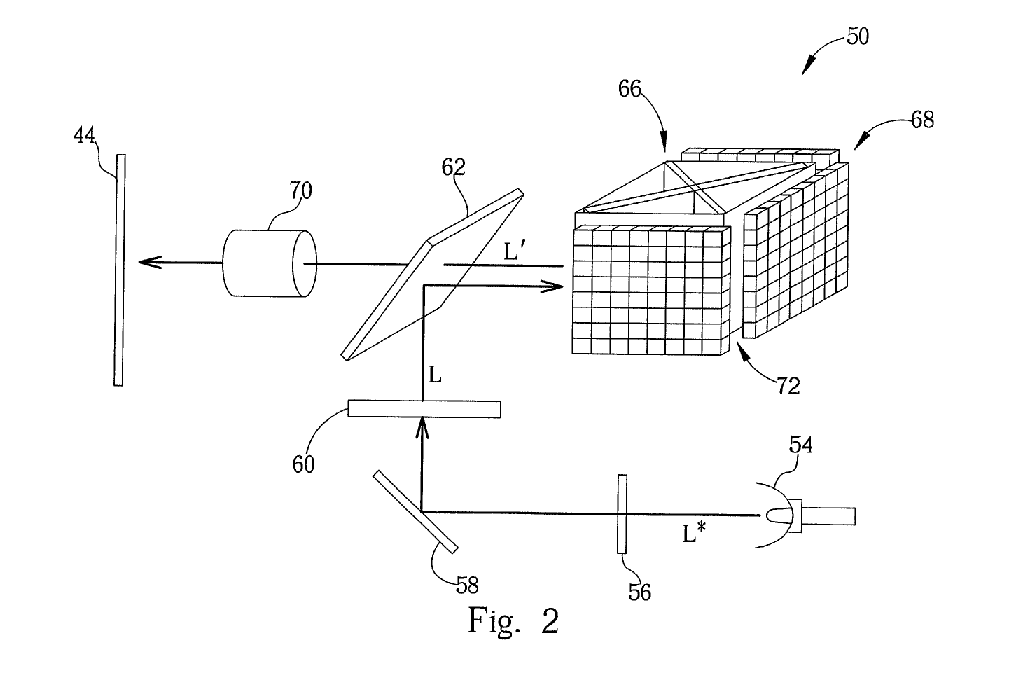

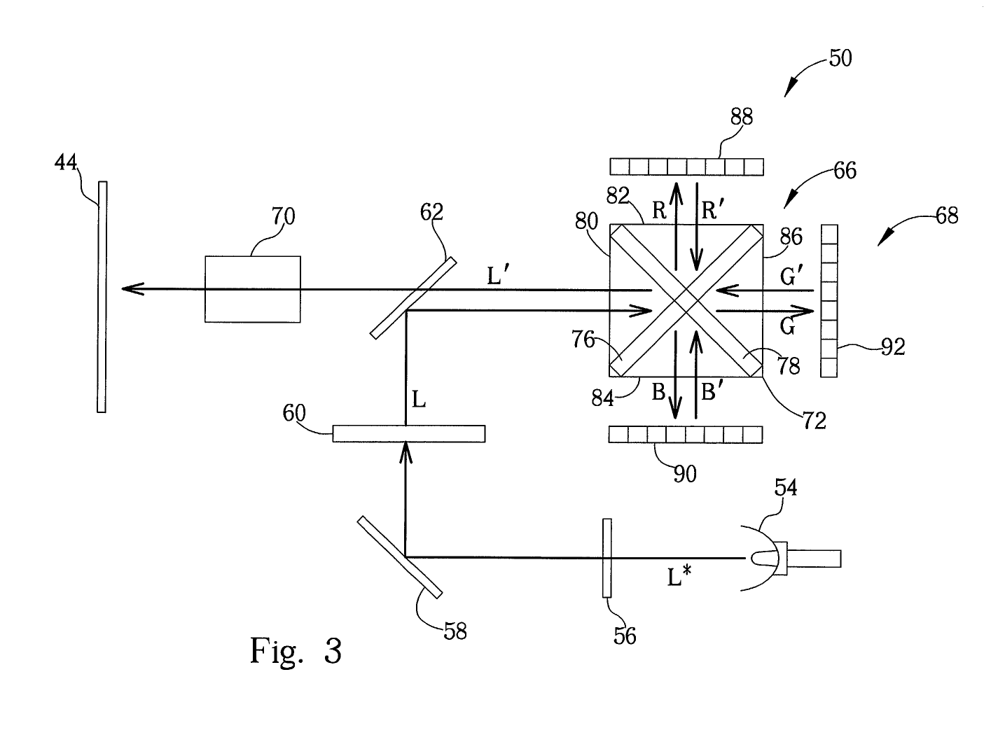

Please refer to FIG. 2 and FIG. 3. FIG. 2 is a schematic view of a present invention first embodiment projection device 50. FIG. 3 is a ray diagram of the projection device 50. The projection device 50 comprises a housing (not shown), a light source 54, a UV/IR (ultraviolet/infrared) cut filter 56, a reflector 58, a polarization converter 60, a polarizing beam splitter 62, a cross dichroic mirror set 66, a modulation device 68, and a projection lens 70. The light source 54 is installed inside the housing and is used to provide white unpolarized light L*. The UV/IR cut filter 56 is used to filter out ultraviolet and infrared light from the white unpolarized light L*. The polarization converter 60 is used to convert the white unpolarized light L* into white polarized light L. The modulation device 68 could be composed of three reflective liquid crystal display panels or three high definition light valves.

The cross dichroic mirror set 66 is used to separate the white polarized light L into three monochromatic polarized beams. The three monochromatic polarized beams are a red polarized beam R, a green polarized beam G, and a blue polarized beam B. The cross dichroic mirror set 66 comprises a transparent rectangular pillar 72, a first side 80, a second side 86, a third side 82, a fourth side 84 and two dichroic mirrors 76 and 78. The first side 80, the second side 86, the third side 82 and the fourth side 84 are the four sides of the pillar 72 and are used to input and output light. The second side 86 is opposite the first side 80, and the third side 82 and the fourth side 84 are both adjacent to the first side 80 and the second side 86. The two dichroic mirrors 76 and 78 are positioned on two diagonal lines of the pillar 72. When the white polarized light L is input into the pillar 72 from the first side 80, the two dichroic mirrors 76 and 78 separate the white polarized light L into the three monochromatic polarized beams R, G, and B. The red polarized beam R and the blue polarized beam B are output from the third side 82 and the fourth side 84 respectively. The green polarized beam G passes through the two dichroic mirrors 76 and 78, and then is output through the second side 86.

The modulation device 68 is positioned adjacent to the cross dichroic mirror set 66 and is used to modulate the three monochromatic polarized beams R, G and B to form three monochromatic polarized modulated beams R′, G′ and B′, and is used to reflect the three monochromatic polarized modulated beams R′, G′ and B′ to the two dichroic mirrors 76 and 78. The modulation device 68 rotates the three monochromatic polarized beams R, G and B to shift the polarization of three monochromatic polarized beams R, G and B. The three monochromatic polarized modulated beams R′, G′ and B′, thus, respectively have polarized direction orthogonal to the corresponding incident three monochromatic polarized beams R, G and B according to a liquid crystal display property or a light valve property. The two dichroic mirrors 76 and 78 recombine the three monochromatic polarized modulated beams R′, G′ and B′ to form a white polarized modulated beam L′. The modulation device 68 comprises three modulation units 88, 90 and 92 which are respectively positioned adjacent to the second side 86, the third side 82 and the fourth side 84. The three modulation units 88, 90 and 92 modulate the red polarized beam R, the blue polarized beam B, and the green polarized beam G respectively to form three monochromatic polarized modulated beams R′, G′ and B′, and then reflect the three monochromatic polarized modulated beams R′, G′ and B′ to the two dichroic mirrors 76 and 78. The two dichroic mirrors 76 and 78 recombine the three monochromatic polarized modulated beams R′, G′ and B′ to form a white polarized modulated beam L′. The white polarized modulated beam L′ radiates out from the first side 80 of the cross dichroic mirror set 66. The three modulation units 88, 90 and 92 could be three reflective liquid crystal display panels, or three high definition light valves.

The polarizing beam splitter 62 reflects the white polarized light L to the first side 80. The white polarized modulated beam L′ passes through the polarizing beam splitter 62 to the projection lens 70. The projection lens 70 then projects the white polarized modulated beam L′ onto the screen 44 to form an image.

As shown in FIG. 3, the ultraviolet and infrared light of the white unpolarized light L* provided by the light source 54 is filtered out by the UV/IR cut filter 56, and then the white unpolarized light L* is reflected to the polarization converter 60 by the reflector 58. The polarization converter 60 converts the white unpolarized light L* into white polarized light L which has S polarization direction. The white polarized light L is reflected to the two dichroic mirrors 76 and 78 through the first side 80. The two dichroic mirrors 76 and 78 separate the white polarized light L into the three monochromatic polarized beams R, G and B. The red polarized beam R passes through the dichroic mirror 78, and is reflected to the modulation unit 88 by the dichroic mirror 76. The blue polarized beam B passes through the dichroic mirror 76, and is reflected to the modulation unit 90 by the dichroic mirror 78. The green polarized beam G passes through the two dichroic mirrors 76 and 78, and is outputted to the modulation unit 92 through the second side 86. The three modulation units 88, 90 and 92 modulate the red polarized beam R, the blue polarized beam B, and the green polarized beam G respectively to form three monochromatic polarized modulated beams R′, G′ and B′, and reflect the three monochromatic polarized modulated beams R′, G′ and B′ to the two dichroic mirrors 76 and 78. The red monochromatic polarized modulated beam R′ passes through the dichroic mirror 78, and is reflected by the dichroic mirror 76. The blue monochromatic polarized modulated beam B′ passes through the dichroic mirror 76, and is reflected by the dichroic mirror 78. The green monochromatic polarized modulated beam G′ passes through the two dichroic mirrors 76 and 78. So, the three monochromatic polarized modulated beams R′, G′ and B′ are recombined to form the white polarized modulated beam L′, which has P polarization direction, and passing through the first side 80 by way of the two dichroic mirrors 76 and 78 of the cross dichroic mirror set 66. The white polarized modulated beam L′ can pass through the beam splitter 62 and get to the projection lens 70. The projection lens 70 projects the white polarized modulated beam L′ onto the screen 44 to form an image.

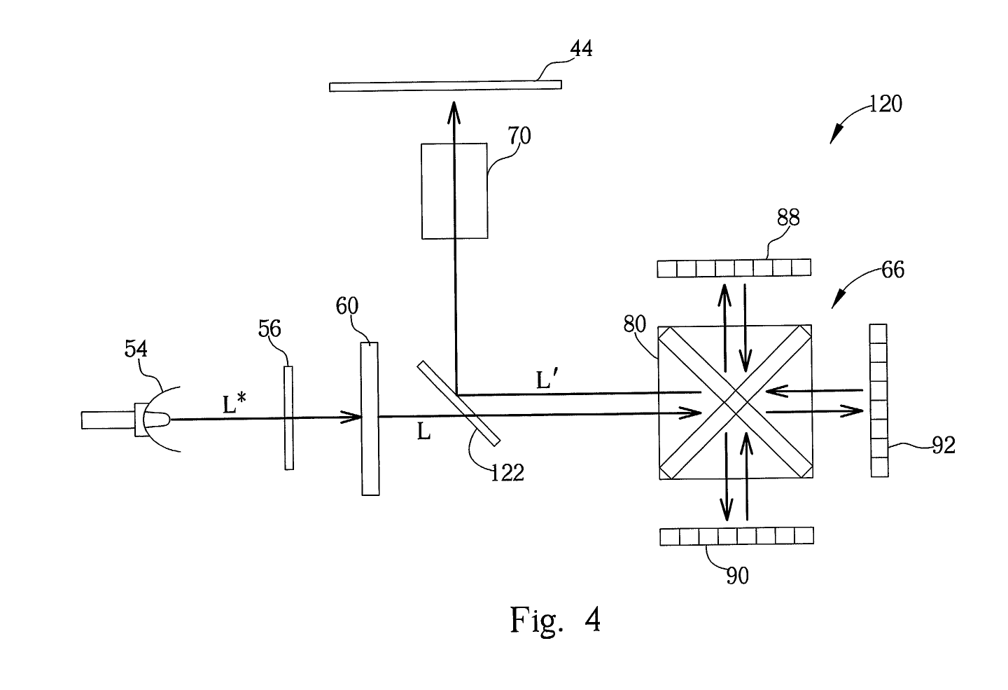

Please refer to FIG. 4. FIG. 4 is a ray diagram of a present invention second embodiment projection device 120. The projection device 120 comprises a polarizing beam splitter 122, and the other components also found in the projection device 50 of FIG. 3. The main difference between the two projection devices 50 and 120 is with the usage of the polarizing beam splitters 62 and 122. The polarizing beam splitter 62 of the projection device 50 reflects the white polarized light L, and through which the white polarized modulated beam L′ passes on to the projection lens 70. The polarizing beam splitter 122 of the projection device 120 reflects the white polarized modulated beam L′, and the white polarized light L passes through the polarizing beam splitter 122 to get to the first side 80. So, the white polarized light L passes through the polarizing beam splitter 122 to get to the first side 80, and the white polarized modulated beam L′ is reflected into a direction that is different from the direction of travel of the white polarized light L.

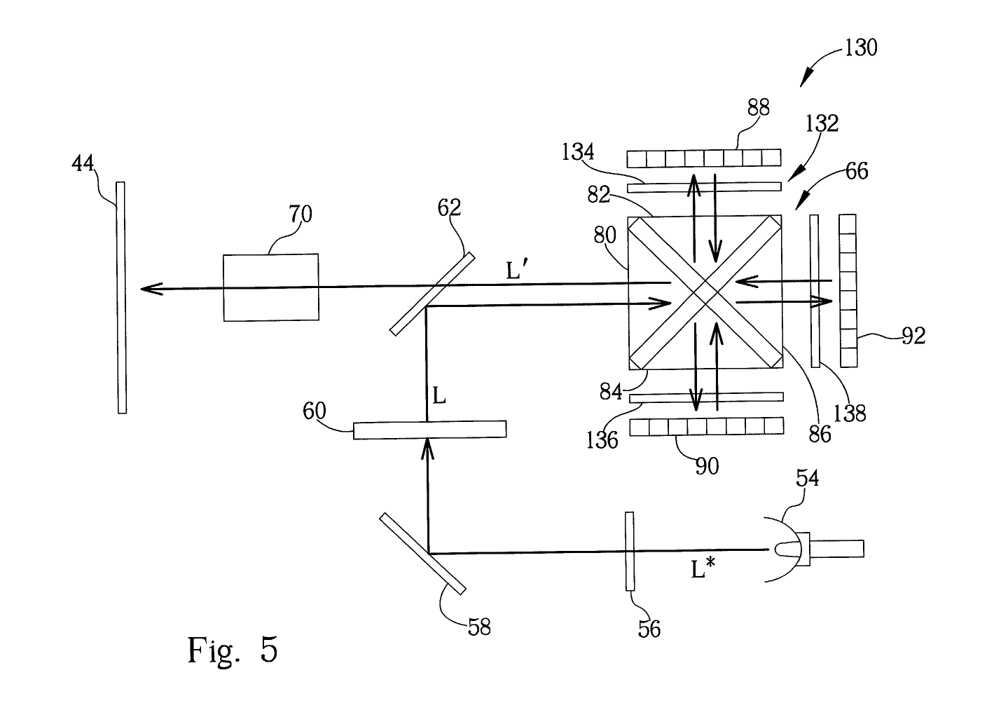

Please refer to FIG. 5. FIG. 5 is a ray diagram of a present invention third embodiment projection device 130. The projection device 130 comprises a retarder 132. The main difference between the two projection devices 50 and 130 is with the retarder 132. Furthermore, the three modulation units 88, 90 and 92 of the projection device 130 are three digital micro-mirror devices. The retarder 132 is composed of three retarding units 134, 136 and 138. The three retarding units 134, 136 and 138 are respectively installed on the second side 86, the third side 82 and the fourth side 84. The three digital micro-mirror devices 88, 90 and 92 are used to modulate the three monochromatic polarized beams R, G and B to form three monochromatic polarized modulated beams R′, G′ and B′, too. Unlike reflective liquid crystal display panels or high definition light valves, the three digital micro-mirror devices 88, 90 and 92 do not rotate the three monochromatic polarized beams R, G and B. The three retarding units 134, 136 and 138 of the retarder 132 are used to retard the three monochromatic polarized beams R, G, and B, and to rotate the three monochromatic polarized modulated beams R′, G′, and B′ respectively. The three monochromatic polarized modulated beams R′, G′ and B′ are recombined to from the white polarized modulated beam L′. So, the polarization of the white polarized modulated beam L′ is opposite to the polarization of the white polarized light L. The white polarized light L, thus, reflects to the first side 80 by the polarizing beam splitter 62, and the white polarized modulated beam L′ is reflected to the projection lens 70.

In contrast to the prior art, the projection devices 50, 120 and 130 comprise two dichroic mirrors 76 and 78. The two dichroic mirrors 76 and 78 have a cross-like arrangement and are used to separate white polarized light L into three monochromatic polarized beams R, G and B. The two dichroic mirrors 76 and 78 also combine three monochromatic polarized beams R′, G′ and B′ to form a white polarized modulated beam L′. The two dichroic mirrors 76 and 78 serve to both separate a white beam into three monochromatic beams, and to combine three monochromatic beams into a white beam. Thus, the number of components in the present invention projection devices 50, 120 and 130 is decreased. The projection devices 50, 120 and 130 have smaller sizes than the prior art projection device 10. The traveling distance of the light is reduced. The quality of the projected image is thus improved.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A projection device comprising:
a housing;
a light source installed inside the housing for providing white unpolarized light;
a polarization converter installed inside the housing for converting the white unpolarized light into white polarized light;
a cross dichroic mirror set having two dichroic mirrors, the two dichroic mirrors having a cross-like arrangement for separating the white polarized light into three monochromatic polarized beams;
a modulation device positioned adjacent to the cross dichroic mirror set for modulating the three monochromatic polarized beams to form three monochromatic polarized modulated beams and that reflects the three monochromatic polarized modulated beams to the two dichroic mirrors, the two dichroic mirrors recombining the three monochromatic polarized modulated beams to form a white polarized modulated beam; and
a projection lens installed inside the housing for projecting the white polarized modulated beam to form an image.

2. The projection device of claim 1 wherein the cross dichroic mirror set further comprises a first side for inputting the white polarized light and outputting the white polarized modulated beam, a second side, a third side, and a fourth side, the second side, the third side and the fourth side being used to output the three monochromatic polarized beams and to input the three monochromatic polarized modulated beams.

3. The projection device of claim 2 wherein the cross dichroic mirror set further comprises a transparent rectangular pillar, and the first side, the second side, the third side and the fourth side are the four sides of the pillar.

4. The projection device of claim 2 wherein the modulation device comprises three reflective liquid crystal display panels respectively installed on the second side, the third side and the fourth side.

5. The projection device of claim 2 wherein the modulation device comprises three high definition light valves respectively installed on the second side, the third side and the fourth side.

6. The projection device of claim 2 wherein the modulation device comprises three digital micro-mirror devices respectively installed on the second side, the third side and the fourth side.

7. The projection device of claim 6 further comprising:
a retarder for rotating the white polarized light and the white polarized modulated beam to shift the polarization of both the white polarized light and the white polarized modulated beam; and
a polarizing beam splitter that reflects the white polarized light to the first side and through which the white polarized modulated beam passes to the projection lens, or through which the white polarized light passes to the first side and which reflects the white polarized modulated beam to the projection lens.

8. The projection device of claim 7 wherein the retarder is a quarter wavelength retarder for rotating the white polarized light and the white polarized modulated beam by a quarter of their respective wavelengths.

9. The projection device of claim 1 further comprising a reflector for reflecting the white unpolarized light to the polarization converter.

10. The projection device of claim 1 further comprising a UV/IR (ultraviolet/infrared) cut filter for filtering out ultraviolet and infrared light from the white unpolarized light, or for filtering out ultraviolet and infrared light from the white polarized light.

11. The projection device of claim 1 wherein the three monochromatic polarized beams are a red polarized beam, a green polarized beam, and a blue polarized beam.

12. A projection device comprising:
a cross dichroic mirror set, the cross dichroic mirror set comprising:
four sides which are nearly rectangularly arranged for inputting light, the four sides being a first side, a second side opposite the first side, a third side and a fourth side, the third side and the fourth side both adjacent to the first side and the second side; and
two crossing dichroic mirrors, each of the dichroic mirrors positioned on a diagonal line of the four sides of the cross dichroic mirror set;
wherein when white polarized light is inputted through the first side into the cross dichroic mirror set, the two dichroic mirrors separate the white polarized light into a first monochromatic polarized beam, a second monochromatic polarized beam, and a third monochromatic polarized beam, the first monochromatic polarized beam and the second monochromatic polarized beam respectively radiating out from the third and the fourth sides, and the third monochromatic polarized beam passing through the two dichroic mirrors and radiating out from the second side;
three modulation units respectively positioned adjacent to the second side, the third side, and the fourth side for modulating the three monochromatic polarized beams to form three monochromatic polarized modulated beams and reflecting the three monochromatic polarized modulated beams to the two dichroic mirrors, the two dichroic mirrors recombining the three monochromatic polarized modulated beams to form a white polarized modulated beam, the white polarized modulated beam radiating out from the first side of the cross dichroic mirror set; and
a polarizing beam splitter for reflecting the white polarized light to the first side of the cross dichroic mirror set and through which passes the white polarized modulated beam, or through which passes the white polarized light to be inputted into the first side of the cross dichroic mirror set and which reflects the white polarized modulated beam into a direction that is different from the direction of travel of the white polarized light.

13. The projection device of claim 12 wherein the three modulation units are three reflective liquid crystal display panels.

14. The projection device of claim 12 wherein the three modulation units are three high definition light valves.

15. The projection device of claim 12 wherein the three modulation units are three digital micro-mirror devices.

16. The projecting device of claim 12 further comprising three retarding units respectively installed on the second side, the third side and the fourth side for rotating the white polarized light and the white polarized modulated beam to shift the polarization of both the white polarized light and the white polarized modulated beam so that the polarization of the white polarized light is opposite to the polarization of the white polarized modulated beam.

17. The projection device of claim 12 wherein the cross dichroic mirror set further comprises a transparent rectangular pillar, and the two dichroic mirrors are positioned on two diagonal lines of the transparent rectangular pillar.

18. The projection device of claim 12 further comprising:
a housing;
a light source installed inside the housing for providing white unpolarized light; and
a polarization converter for converting the white unpolarized light into the white polarized light.

19. The projection device of claim 12 further comprising a projection lens for projecting the white polarized modulated beam to form an image.

20. A projection device comprising:
a cross dichroic mirror set, the cross dichroic mirror set comprising:
four sides which are nearly rectangularly arranged for inputting light, the four sides being a first side, a second side opposite the first side, a third side and a fourth side, the third side and the fourth side both adjacent to the first side and the second side; and
two crossing dichroic mirrors, each of the dichroic mirrors positioned on a diagonal line of the four sides of the cross dichroic mirror set;
wherein when white polarized light is inputted through the first side into the cross dichroic mirror set, the two dichroic mirrors separate the white polarized light into a first monochromatic polarized beam, a second monochromatic polarized beam, and a third monochromatic polarized beam, the first monochromatic polarized beam and the second monochromatic polarized beam respectively radiating out from the third and the fourth sides, and the third monochromatic polarized beam passing through the two dichroic mirrors and radiating out from the second side;
three reflective liquid crystal display panels respectively positioned adjacent to the second side, the third side, and the fourth side for modulating the three monochromatic polarized beams to form three monochromatic polarized modulated beams and reflecting the three monochromatic polarized modulated beams to the two dichroic mirrors, the two dichroic mirrors recombining the three monochromatic polarized modulated beams to form a white polarized modulated beam, the white polarized modulated beam radiating out from the first side of the cross dichroic mirror set; and
a polarizing beam splitter for reflecting the white polarized light to the first side of the cross dichroic mirror set and through which passes the white polarized modulated beam, or through which passes the white polarized light to be inputted into the first side of the cross dichroic mirror set and which reflects the white polarized modulated beam into a direction that is different from the direction of travel of the white polarized light.

21. The projection device of claim 20 wherein the cross dichroic mirror set further comprises a transparent rectangular pillar, and the two dichroic mirrors are positioned on two diagonal lines of the transparent rectangular pillar.

22. The projection device of claim 20 further comprising:
a housing;
a light source installed inside the housing for providing white unpolarized light; and
a polarization converter for converting the white unpolarized light into the white polarized light.

23. The projection device of claim 20 further comprising a projection lens for projecting the white polarized modulated beam to form an image.

24. A projection device comprising:
a cross dichroic mirror set, the cross dichroic mirror set comprising:
four sides which are nearly rectangularly arranged for inputting light, the four sides being a first side, a second side opposite the first side, a third side and a fourth side, the third side and the fourth side both adjacent to the first side and the second side; and
two crossing dichroic mirrors, each of the dichroic mirrors positioned on a diagonal line of the four sides of the cross dichroic mirror set;
wherein when white polarized light is inputted through the first side into the cross dichroic mirror set, the two dichroic mirrors separate the white polarized light into a first monochromatic polarized beam, a second monochromatic polarized beam, and a third monochromatic polarized beam, the first monochromatic polarized beam and the second monochromatic polarized beam respectively radiating out from the third and the fourth sides, and the third monochromatic polarized beam passing through the two dichroic mirrors and radiating out from the second side;
three high definition light valves respectively positioned adjacent to the second side, the third side, and the fourth side for modulating the three monochromatic polarized beams to form three monochromatic polarized modulated beams and reflecting the three monochromatic polarized modulated beams to the two dichroic mirrors, the two dichroic mirrors recombining the three monochromatic polarized modulated beams to form a white polarized modulated beam, the white polarized modulated beam radiating out from the first side of the cross dichroic mirror set; and
a polarizing beam splitter for reflecting the white polarized light to the first side of the cross dichroic mirror set and through which passes the white polarized modulated beam, or through which passes the white polarized light to be inputted into the first side of the cross dichroic mirror set and which reflects the white polarized modulated beam into a direction that is different from the direction of travel of the white polarized light.

25. The projection device of claim 24 wherein the cross dichroic mirror set further comprises a transparent rectangular pillar, and the two dichroic mirrors are positioned on two diagonal lines of the transparent rectangular pillar.

26. The projection device of claim 24 further comprising:
a housing;
a light source installed inside the housing for providing white unpolarized light; and
a polarization converter for converting the white unpolarized light into the white polarized light.

27. The projection device of claim 24 further comprising a projection lens for projecting the white polarized modulated beam to form an image.

28. A projection device comprising:
a cross dichroic mirror set, the cross dichroic mirror set comprising:
four sides which are nearly rectangularly arranged for inputting light, the four sides being a first side, a second side opposite the first side, a third side and a fourth side, the third side and the fourth side both adjacent to the first side and the second side; and
two crossing dichroic mirrors, each of the dichroic mirrors positioned on a diagonal line of the four sides of the cross dichroic mirror set;
wherein when white polarized light is inputted through the first side into the cross dichroic mirror set, the two dichroic mirrors separate the white polarized light into a first monochromatic polarized beam, a second monochromatic polarized beam, and a third monochromatic polarized beam, the first monochromatic polarized beam and the second monochromatic polarized beam respectively radiating out from the third and the fourth sides, and the third monochromatic polarized beam passing through the two dichroic mirrors and radiating out from the second side;
three digital micro-mirror devices respectively positioned adjacent to the second side, the third side, and the fourth side for modulating the three monochromatic polarized beams to form three monochromatic polarized modulated beams and reflecting the three monochromatic polarized modulated beams to the two dichroic mirrors, the two dichroic mirrors recombining the three monochromatic polarized modulated beams to form a white polarized modulated beam, the white polarized modulated beam radiating out from the first side of the cross dichroic mirror set; and
a polarizing beam splitter for reflecting the white polarized light to the first side of the cross dichroic mirror set and through which passes the white polarized modulated beam, or through which passes the white polarized light to be inputted into the first side of the cross dichroic mirror set and which reflects the white polarized modulated beam into a direction that is different from the direction of travel of the white polarized light.

29. The projecting device of claim 28 further comprising three retarding units respectively installed on the second side, the third side and the fourth side for rotating the white polarized light and the white polarized modulated beam to shift the polarization of both the white polarized light and the white polarized modulated beam so that the polarization of the white polarized light is opposite to the polarization of the white polarized modulated beam.

30. The projection device of claim 28 wherein the cross dichroic mirror set further comprises a transparent rectangular pillar, and the two dichroic mirrors are positioned on two diagonal lines of the transparent rectangular pillar.

31. The projection device of claim 28 further comprising:
a housing;
a light source installed inside the housing for providing white unpolarized light; and
a polarization converter for converting the white unpolarized light into the white polarized light.

32. The projection device of claim 28 further comprising a projection lens for projecting the white polarized modulated beam to form an image.
